(19) United States
(12) Patent Application Publication
(10) Pub. No.: US 2006/0136897 A1
(43) Pub. Date: Jun. 22, 2006

(54) System and method for a packaging and deployment mechanism for Web service applications

(76) Inventors: Chaitanya Laxminarayan, Austin, TX (US); Matthew Sanchez, Round Rock, TX (US); Keith Yarbrough, (US)

Correspondence Address: RICK B. YEAGER, ATTORNEY, 10805 MELLOW LANE, AUSTIN, TX, 78759, US

(21) Appl. No.: 11/021,433

(22) Filed: Dec. 22, 2004

(51) Int. Cl. G06F 9/44

(52) U.S. Cl. 717/168

(57) ABSTRACT

A packaging utility is created that can in turn create a deployment archive (DAR) file containing the data required to install a Web service application, comprising, for example, portlets for creating Web pages for the Web service's user interface, UDDI entries, executable programs, and application-wide properties. The application-wide properties may comprise elements to be used in connection with one or more Web services, for example, encryption levels, service levels, timeouts, and number of retries. For administration efficiency the application-wide properties may be applied according to hierarchies, for example from groupings of Web services to individual Web services and from organizations of users to individual users. An unpackaging tool is created to unpackage and install the DAR file on a target environment. A configuration set is employed by the unpackaging tool to determine where the elements of the Web service application are to be installed on the target environment.

### FIELD OF THE INVENTION

This innovation relates to Web services, and, more particularly, to methods for installing a Web service application on a target environment.

### BACKGROUND OF THE INVENTION

Web Services

The promise of the Internet is an open e-business platform where companies can do business spontaneously with anyone, anywhere, and anytime without requiring that companies abandon their existing software applications and infrastructures. Increasingly companies rely on the Internet to obtain loosely coupled Web services deployed by Web service application providers on application-based servers, which are computers on networks that mange the networks.

Web services are business-enterprise computer applications that can be utilized singly or collectively to accomplish a wide range of intended purposes, such as determining health-care patients' eligibility for benefits, submitting health-care claims, and providing stock quotes. Web services help companies dramatically cut costs, increase revenues, and improve competitive agility by combining existing, heterogeneous systems into cross-functional, multi-company applications. For example, Web services designed for insurance companies help them rapidly automate their business processes, eliminating paper and manual touches and saving them tens of millions of dollars annually. To supply such valuable and widely needed services, Web service providers may offer multiple Web services to client businesses.

Because Web services can operate independently of a particular computer language, platform, or location, a client business and a Web service may each use different computer languages, platforms, and locations in widely distributed systems over one or more networks.

Open Web service standards have been developed for compatibility among Web service applications. A standard called SOAP (Simple Object Access Protocol) has been developed to define the format of messages exchanged among applications. The content of messages, such as a request for an action to be performed by a Web service, is currently described in WSDL (Web Services Description Language), which is an XML (Extensible Markup Language)-formatted language. Web services are cataloged in a Web-based directory and infrastructure called UDDI (Universal Description, Discover and Integration), which is an Internet registry where businesses list themselves according to their services. Communications between a client business and a Web service further rely on the use of a shared transport protocol, such as HTTP (Hypertext Transport Protocol), which enables communications over the Internet.

Typically a client business employs a client application to communicate from its Web site over the Internet according to these standards, to obtain the Web services offered by a Web service application provider from its server-based Web site. The Web service application provider uses the same standards to reply to a client. Other known or not-yet-known Web service protocols and standards may be used for this communications.

Web Service Applications

Web service applications are computer applications that use Web services singly or collectively to accomplish intended purposes. To work with a specific Web service application, a Web service needs accept business documents, process them, and pass them on in ways compatible with the Web service application.

A Web service application typically consists of one or more Web services, a document that describes how those Web services are choreographed and used and those Web services' Web portal pages and UDDI entries.

FIG. 1 shows an example of how multiple Web services are typically used as part of a Web service application for the filing and payment of medical insurance claims. A Web service application provider employs a server 100 running a Web portal page 200 and a Web service application 240.

A Web portal page 200 is a Web-site interface that a person can reach over the Internet. Web-site interfaces are computer-programmed modules that allow end-users to select variables and parameters from easy-to-use visual displays or to type in this input, save the information through selecting a save option, and have their selections automatically applied by computer subsequently, without those users having to program the information manually.

In this example, an attendant at a clinic computer 150 can use the Internet, through a wired link 144, a telephone network 130, and another wired link 142, to reach the portal Web page 200 on the Web service application provider server 100. The attendant can then use the portal Web page 200 to fill out a claim file form 220 for one of the clinic's patients and submit it to Web service application 1 240.

Other means for submitting claims also exist. For example, an attendant at a hospital computer 160 might use link 146, network 130, and link 142 for a machine-to-machine transmission of a claim file directly to Web service application 1 220. Many kinds of wired and unwired links and networks could used for this machine-to-machine transmission, such as the Internet, a private LAN (Local Area Network), a wireless network, a TCP/IP (Transmission Control Protocol/Internet Protocol) network, or other communications system.

To continue with the example, Web service application 1 240 receives each claim file through Web service 1 241 and, if necessary, uses Web service 2 to transform the format of the claim file to a format that Web service application 1 240 can use for its full operations. For example, a claim file might have been sent in NSF (National Science Foundation) format, but Web service application 1 240 might require HIPAA (Health Insurance Portability and Accountability Act) format.

After the claim file is transformed to the correct message format, Web service 3 243 is used to validate the claim file, and Web service 4 244 is used to send the claim file back over link 142, network 130, and link 148 to an insurance company server 170 for payment to the clinic.

The same process is also typically carried out over networked systems in which a Web service application 240 employs Web services on multiple different servers, as shown in FIG. 2. In this system, Web service 1 241 is on server 100, Web service 2 242 is on server 2 182, Web service 3 243 is on server 3 184, and Web service 4 186 is on server 4 186. All these elements communicate through network 130 and multiple links 142, 143, 144, 145, 147, and 148.

Because of the value of Web service applications, Web service application providers typically offer them to clients for sale or lease. A client business that buys or leases a Web service application may run that application on one of the Web service application provider's servers. On the other hand, client businesses frequently want to run a bought or leased Web service application on their own servers. In other cases, client businesses may want to test or further develop third-party Web service applications on their own servers. Therefore, as shown in FIG. 3, means are needed to create Web service applications, such as Web service application 1 240 and Web service application 2 250, on one environment, for example on an operating system such as Web service application provider server 100, and load and run them on a target environment, for example on other operating systems such as server 2 182 and server 3 184.

Prior Methods

Typically, Web service applications are transferred manually after being loaded on storage means such as computer discs or electronically through transmission over the Internet or other communication means. However, in both cases the process of moving a Web service application from one operating environment to another operating environment requires manual installation of some of the Web service application's components and the editing of the Web service application's instruction document to reflect the new locations. This makes the process very laborious, error prone, and expensive.

In addition, prior packaging/unpacking utilities have been devised for Web service application installations, but these are not fully automatic. They do not account for the semantic dependencies among various Web service application components and how those components are to be packaged, unpackaged and installed in an integral manner to coexist with each other.

For example, enterprise archives (EAR) and Web-application archives (WAR) have been used to deploy applications in J2 EE environments. But both of these archives can only put a single application on a single machine. In connection with Web services, these archives can only place a single Web service on a single server and can neither place a Web service application on a server nor place multiple chained Web services on multiple servers. To deploy a networked Web service application, such as Web service 1 240 in FIG. 2, with multiple Web services on multiple servers, would require using multiple EARS or WARs.

Therefore there is a need for a method and apparatus that provides a more automatic method for installing Web service applications on target environments that may include one or more servers.

### BRIEF SUMMARY OF THE INVENTION

These and other needs are addressed by the present invention. The following explanation describes the present invention by way of example and not by way of limitation.

It is an aspect of the present invention to provide an automatic method for installing a Web service application on a target environment.

It is another aspect of the present invention to provide a deployment archive (DAR) file that is useful for installing a Web service application on a target environment.

It is another aspect of the present invention to provide a method for the automatic packaging of Web service application installation data into a DAR file.

It is another aspect of the present invention to provide a method for the automatic unpackaging of a DAR file.

It is another aspect of the present invention to provide a configuration set for installing a Web service application on a target environment.

These and other aspects, features, and advantages are achieved according to the method and apparatus of the present invention. In accordance with the present invention, a packaging utility is created that can in turn create a deployment archive (DAR) file containing the data required to install a Web service application, comprising, for example, portlets for creating Web pages for the Web service's user interface, UDDI entries, executable programs, and application-wide properties. The application-wide properties may comprise elements to be used in connection with one or more Web services, for example, encryption levels, service levels, timeouts, and number of retries. For administration efficiency the application-wide properties may be applied according to hierarchies, for example from groupings of Web services to individual Web services and from organizations of users to individual users. An unpackaging tool is created to unpackage and install the DAR file on a target environment. A configuration set is employed by the unpackaging tool to determine where the elements of the Web service application are to be installed on the target environment.

### BRIEF DESCRIPTION OF THE DRAWINGS

The following embodiment of the present invention is described by way of example only, with reference to the accompanying drawings, in which:

FIG. 1 is a block diagram that shows an example of how multiple Web services are typically used as part of a Web service application for the filing and payment of medical insurance claims;

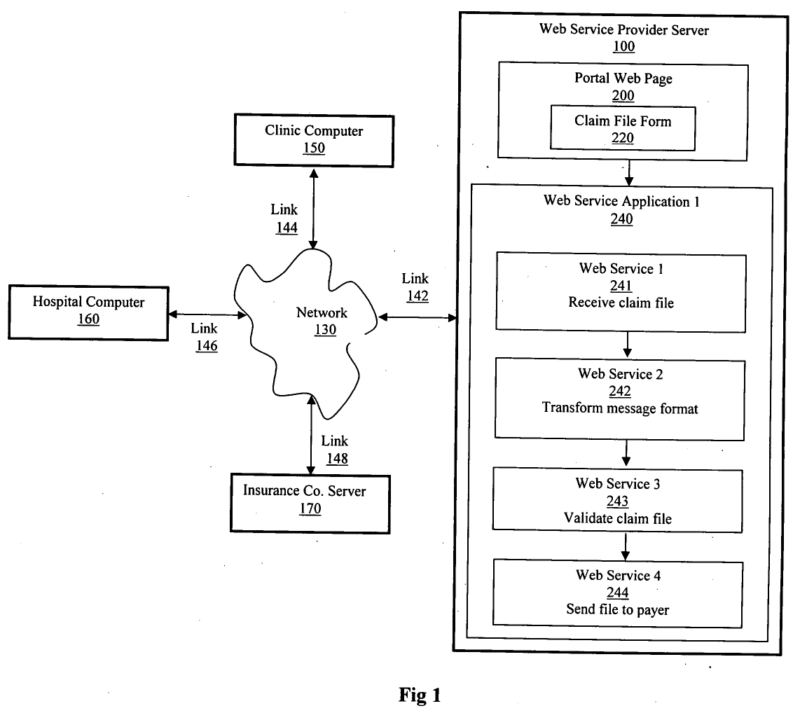

FIG. 2 is a block diagram that illustrates a networked system in which a web service application employs Web services on multiple servers for the filing and payment of medical insurance claims;

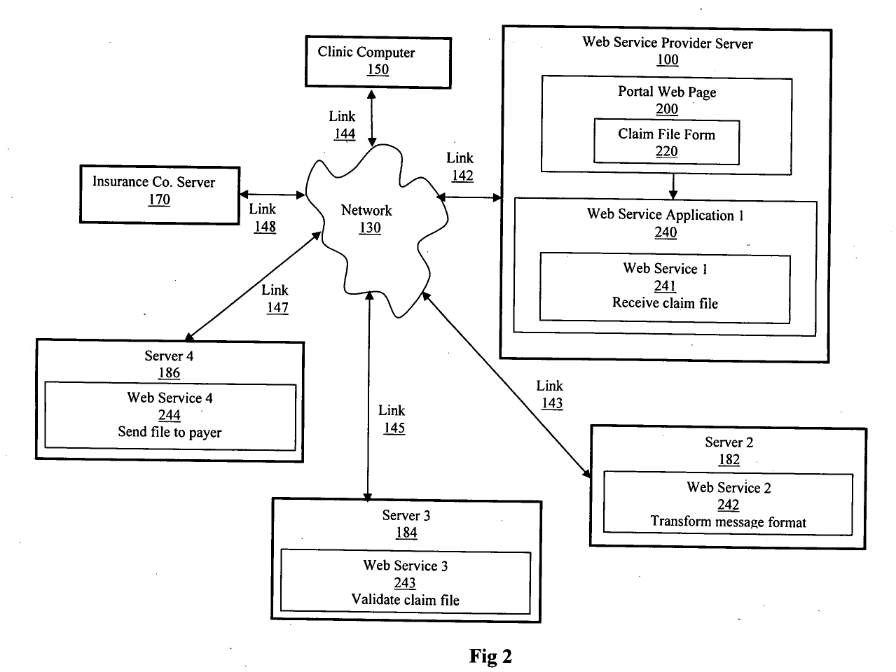

FIG. 3 is a block diagram that illustrates the need to transfer Web service applications from a source server to a target environment with multiple servers;

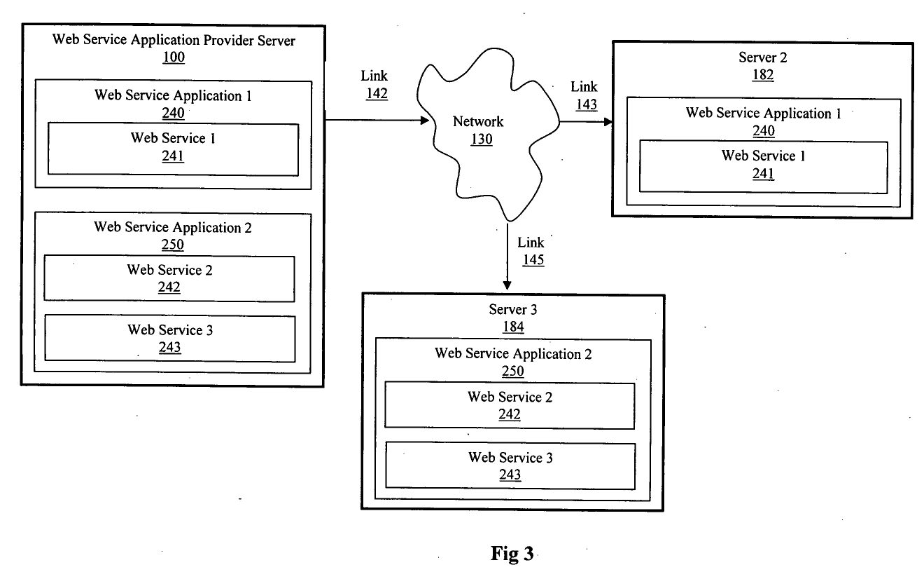

FIG. 4 is a block diagram showing an operating environment in which embodiments of the present invention may be employed;

FIG. 5 is top-level flow chart that illustrates a process for transferring a Web service application from a source environment to a target environment;

FIG. 6 is a block diagram that illustrates the elements of DAR tools in an embodiment;

FIG. 7 is a block diagram that shows examples of useful installation data;

FIG. 8 is a block diagram that shows the elements of an unpackaging utility;

FIG. 9 is a block diagram that illustrates how installation data may contain data for groupings of Web service applications.

FIG. 10 is a block diagram that illustrates examples of groupings of Web service applications;

FIG. 11 is a block diagram that illustrates a typical computer system, representing a Web service application provider server on which embodiments of the present invention can be implemented; and

FIG. 12 is a block diagram showing an operating environment in which alternate embodiments of the present invention may be employed.

### DETAILED DESCRIPTION

The following description explains a system and method that automatically deploys a Web service application on a target environment. The details of this explanation are offered to illustrate the present invention clearly. However, it will be apparent to those skilled in the art that the concepts of the present invention are not limited to these specific details. Commonly known elements are also shown in block diagrams for clarity, as examples and not as limitations of the present invention.

Operating Environment

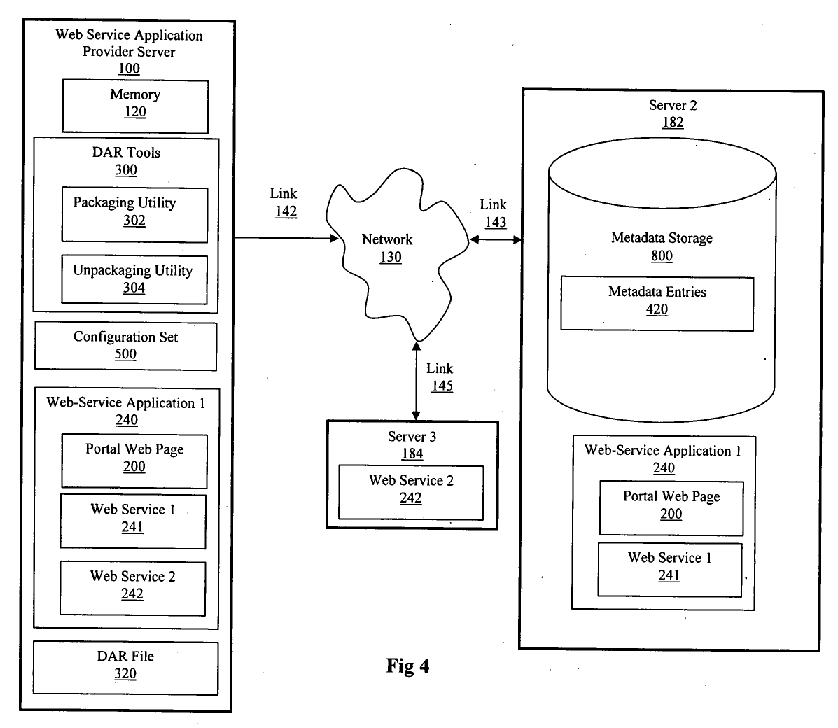

An embodiment of the operating environment of the present invention is shown in FIG. 4. A Web service application provider employs server 100 to create Web service application 1 240 comprising one or more Web services, such as Web service 1 241 and Web service 2 241, and portal Web page 200. The Web service application provider also creates deployment archive (DAR) tools 300, comprising a packaging utility 302 and an unpackaging utility 304. In addition, the Web service application provider creates a configuration set 500 about the configuration of a target environment comprising one or more servers 182 and 184.

The DAR tools 300 are useful for transferring Web service application 240 to a target environment comprising servers 182 and 184 via a wired or wireless link 142, a wired or wireless network 130, and wired or wireless links 143 and 145.

The servers 100, 182, and 184 may be personal computers or larger computerized systems or combinations of systems.

The network 130 may be the Internet, a private LAN (Local Area Network), a wireless network, a TCP/IP (Transmission Control Protocol/Internet Protocol) network, or other communications system, and can comprise multiple elements such as gateways, routers; and switches. Links 142, 143, and 145 use technology appropriate for communications with network 130.

Through the operating environment shown in FIG. 4, a Web service application provider can deploy Web service application 1 240 from a source environment such as server 100 to a target environment such as servers 182 and 184 a Web service application 1 240.

In other embodiments elements of the present invention may be created and employed in more widely dispersed systems. For example, the DAR tools 300 could be created on server 100 and sent to another server such as server 2 182 for use on a Web service application created on server 2 184. The DAR tools 300 could then be used to deploy the Web service application on server 2 184 to server 3 100.

In another embodiment, the configuration set 500 could be created on one server 182 and sent to another server 100 for use with the DAR tools 300 to deploy Web service application 1 240 on server 2 182.

Also note that other embodiments may be used to update existing Web service applications on target environments and to incorporate existing Web services on target environments into Web service applications.

Process of Deploving a Web service Application—Overview

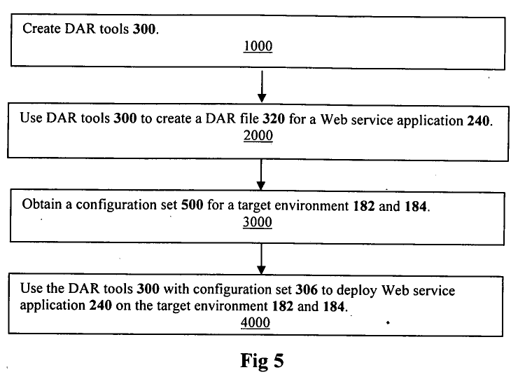

FIG. 5 is top-level flow chart that illustrates a process for transferring a Web service application 240, shown in FIG. 4, from a source environment such as server 100 to a target environment such as servers 182 and 184. It will be useful to explain the steps in this process briefly from a high level and then to expand elements of this explanation in detail.

Step 1000 in FIG. 5. Create DAR tools 300.

In an embodiment, a Web service application provider creates DAR (Deployment Archive) tools 300, shown in FIG. 4, useful for transferring the elements of any web service application, such as Web service application 240, to a target environment 182 and 184. DAR tools 300 may comprise a packaging utility 302 to package data useful for deploying any web service application, such as Web service application 240, and an unpackaging utility 304 to unpackage that data and to deploy that data on a target environment 182 and 184.

Step 2000 in FIG. 5. Use DAR tools 300 to create DAR file 320 for a Web service application 240.

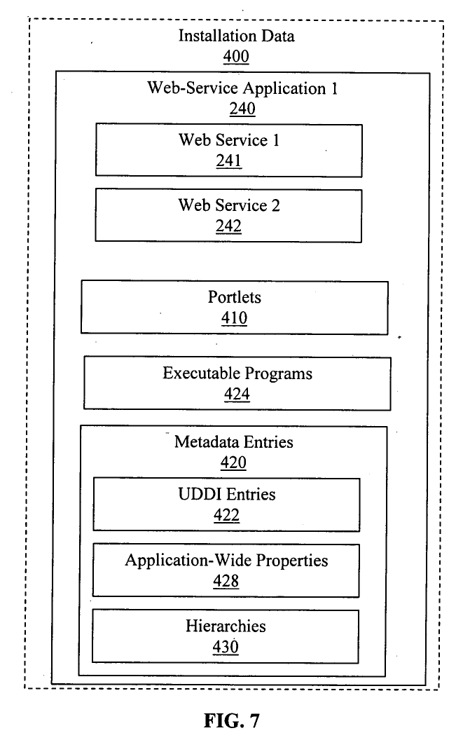

In an embodiment, the Web service application provider employs packaging utility 302, shown in FIG. 4, to package installation data 400, shown in FIG. 7, useful for deploying a specific Web service application 240, shown in FIG. 4, into a DAR file 320.

The Web service application 240, shown in FIG. 4, may comprise one or more Web services 241 and 242 and, if useful, one or more portal Web pages 200.

Step 3000 in FIG. 5. Obtain a configuration set 500 for a target environment 182 and 184.

In an embodiment, the Web service application provider creates a configuration set 500, shown in FIG. 4, containing information about the configuration of the target environment 182 and 184. This information specifies where to install the elements of a Web service application 240 on the target environment 182 and 184.

In another embodiment, the Web service application provider receives a configuration set 500, containing information about the configuration of the target environment 182 and 184, from a party at the target environment, such as a party at server 2 182.

Step 4000 in FIG. 5. Use the DAR tools 300 with configuration set 306 to deploy Web service application 240 on the target environment 182 and 184.

In an embodiment, the Web service application provider employs the DAR tools 300, shown in FIG. 4, to unpackage the DAR file 320 and to deploy the installation data 400, shown in FIG. 7, for Web service application 240, shown in FIG. 4, on target environment 182 and 184 according to the specifications in the configuration set 500.

Creating DAR Tools

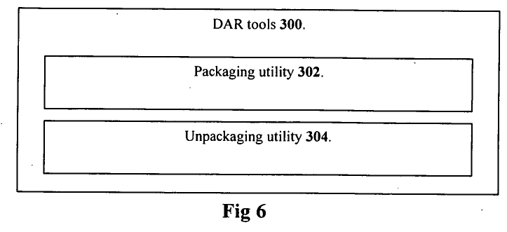

FIG. 6 illustrates the elements in an embodiment of DAR tools 300.
A packaging utility 302; and
An unpackaging utilty 304.

Packaging Utility

In an embodiment, the Web service application provider creates a packaging utility 302 to assemble, from the file folders, databases, and UDDI of the Web service application provider's server 100, shown in FIG. 4, installation data 400, shown in FIG. 7, useful to deploy a Web service application 240, shown in FIG. 4.

The packaging utility 302 also writes the installation data, 400, shown in FIG. 7 to a DAR file 320, as explained below.

Installation Data

FIG. 7 shows examples of useful information data 400, comprising information about the following:
Web service application 1 240, shown in FIG. 4
Web service 1 241
Web service 2 242
Portlets 410, shown in FIG. 7—Packaging utility 302, shown in FIG. 4, assembles information about the user interface for the Web service application 240, such as portal Web pages, and creates software programs called portlets to deploy that user interface.
Executable Programs 424, shown in FIG. 7—software programs used by Web services and portal pages to provide functionality. For example, executable Programs 424, shown in FIG. 7, may provide for logging, invoking Web services, encryption, and programs to run the portlets 410.

In an embodiment, executable Programs 424, shown in FIG. 7, may comprise application-wide classes and JARs, which refer to standard code and Java Archives (JAR) used by Web services.
Metadata entries 420, shown in FIG. 7—These comprise further information about the location and features of Web service application 1 240, shown in FIG. 4, and its Web services 241 and 242.

Metadata Entries

The following are examples of useful elements for metadata entries 420, shown in FIG. 7:
UDDI entries 422—Internet registry data listing the services of Web service application 1 240, shown in FIG. 4
Application-wide properties 428, shown in FIG. 7—These refer to properties associated with one or more Web services and portal pages comprising, for example, the encryption level for messages, business service levels, and the timeout and number of retries used in communications.
Hierarchies 430—For administration efficiency the applications-wide properties may be applied according to hierarchies, for example from groupings of Web services to individual Web services and from organizations of users to individual users.

Hierarchies

In connection with the above-mentioned application-wide properties and hierarchies, this application is related to pending utility patent application 10/898633, Method and Apparatus for Dynamic, Non-Intrusive Personalization of Web Services, for Chaitanya Laxminarayan, Michael Perham, Matthew Sanchez, and Keith Yarbrough.

For simpler administration of application-wide properties 428, shown in FIG. 7, the Web service application provider may set up multiple kinds of hierarchies 430, by which parameters specified at a higher level are automatically applied to categories at a lower level. Parameters specified individually for a lower-level category will override parameters from a higher category, but only for that lower-level category and for the categories beneath that lower-level category.

Examples of useful categories for hierarchies 430 comprise Web service hierarchies and user hierarchies.

Web Service Hierarchies

The following list shows an example of a Web service hierarchy comprising the following categories:
Suite of applications, at the highest level;
Application, at the second highest level;
Business service, at the third highest level; and
Web service, at the lowest level.

For example, a Web service application provider might offer, along with other suites of services, a “Health Care” suite of multiple health-care related services. At the application level, the Web service application provider might set up multiple applications, including one for “Claims Filing.” At the business service level the Web service application provider could set up multiple business services, with one for “Claims Uploading,” and. at the Web service level, multiple Web services, with one called “Upload Service.”

To utilize this hierarchy for simpler administration, the Web service application provider would set up a conversion algorithm so that all parameters set up for the “Health Care” Network would apply automatically to Claims Filing, Claims Upload, and Upload Service. A parameter set up directly for the Claims Upload service, however, would override the analogous parameter set up for Heath Care and would also apply to the Claims Upload and Upload Services.

User Hierarchies

A Web service application provider can also organize a user hierarchy of multiple levels for simplified administration of application-wide properties. In an embodiment, the highest level is for the organization, the next highest level is for the group, and the lower level is for the individual, who is one of potentially multiple users belonging to the organization. For example, the organization level could represent a system administrator, the group level could represent an administrator, and the individual level could represent an end-user.

Further useful divisions of these hierarchies are possible. For example, the organization level could itself be further divided into sub-organizations. Company A might be the organization level, with sub-organizations called “Sales Division” and “Development Division.”

Combined Hierarchical Order

The following example shows a section of an algorithm for administering hierarchies 430, shown in FIG. 7:
Determine the parent categories of the Web service
For each category in that hierarchy from least to most specific do
   Get values for <suite of applications, now>
   Get values for <suite of applications, organization, now>
   Get values for <suite of applications, group, now>
   Get values for <suite of applications, individual, now>
Done

This algorithm uses the hierarchies to apply parameters in the following combined hierarchical order:
suite of applications
suite of applications, organization
suite of applications, group
suite of applications, individual
application
application, organization
application, group
application, individual
business service
business service, organization
business service, group
business service, individual
Web service
Web service, organization
Web service, group
Web service, individual

Unpackaging Utility

To return to FIG. 6, the next step in creating DAR tools 300 in an embodiment is the following:

Step 2020 in FIG. 6. Create unpackaging utility 304.

In an embodiment, the Web service application provider creates an unpackaging utility 304, shown in FIG. 4, to unpackage the installation data 400, shown in FIG. 7, packaged by packaging utility 302, shown in FIG. 4.

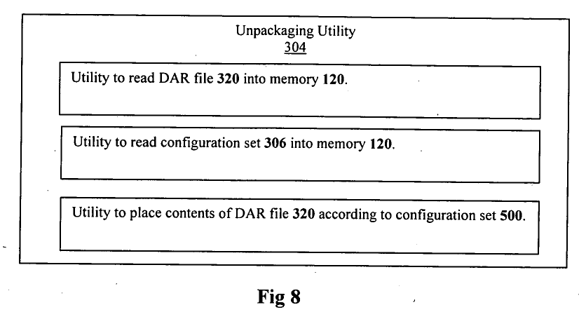

FIG. 8 shows the elements employed by unpackaging utility 304:
A utility to read the DAR file 320, shown in FIG. 4, into memory 120—In an embodiment, this utility reads the DAR file 320 into memory 120 on server 100.
A utility to read configuration set 500 into memory 120—In an embodiment, this utility reads the configuration set 500, explained below, into memory 120 on server 100.
A utility to place contents of DAR file 320 according to configuration set 500—In an embodiment, this utility deploys the contents of DAR file 320 on target environment 182 and 184.

The DAR File

To return to FIG. 5, the next step in the process of deploying a Web service application in an embodiment is the following:

Step 2000 in FIG. 5. Use DAR tools 300 to create a DAR file 320 for a Web service application 2000.

In an embodiment, the Web service application provider employs packaging utility 302, shown in FIG. 4, to package installation data 400, shown in FIG. 7, useful for deploying a specific Web service application 240, shown in FIG. 4, into a DAR file 320.

A DAR (deployment archive) file 320 contains all the data required to install Web service application 1 240, comprising, for example, the programs that make up the Web services 241 and 242, portlets 410, shown in FIG. 7, for creating Web pages for the user interface, UDDI entries 422, executable programs 424, application-wide properties 428, and hierarchies 430.

Configuration Set

To return to FIG. 5, the next step in the process of deploying a Web service application in an embodiment is the following:

Step 3000 in FIG. 5. Obtain a configuration set 500 for target environment 182 and 184.

In an embodiment the Web service application provider may employ server 100, shown in FIG. 4, to create a configuration set 500 about the configuration of the target environment 182 and 184. The configuration set 500 comprises data about where the elements associated with Web service application 1 240 are to be located in the target environment. In other embodiments the configuration set 500 could be created at the target environment on server 2 182 or server 3 184 by a different person from the person who creates the Web service application 240 and could be sent to server 100. The configuration set 500 is unique to the specific Web service application 240 to be deployed and to the specific target environment 182 and 184.

For example, in the example shown in FIG. 4 configuration set 500 could contain the following instructions:
Place portal pages for Web service application 1 240 on server 2 182;
Place executable programs 424 for Web service application 1 240;
Place metadata entries 420 for Web service application 1 240 in metadata storage 800 on server 2 182;
Place programs for Web service 1 241 on server 2 182;
Place programs for Web service 2 242 on server 3 184;
Place executable program on server 3 184.

Deploying the Web Service Application

In an embodiment, the next step in the process shown in FIG. 5 is the following:

Step 4000. Use the DAR tools 300 with configuration set 500 to deploy a Web service application, such as Web service application 1 240 on target environment 182 and 184.

The Web service application provider employs the unpackaging utility 304, shown in FIG. 4, to
Read the DAR file 320 into memory 120 on server 100;
Read configuration set 500 into memory 120; and
Place the contents of DAR file 320 according to configuration set 500.

As a result, all the installation data required for Web service application 1 is sent automatically to the target environment 182, shown in FIG. 4, and 184.

In another embodiment the DAR file 320 may be saved to a storage means, comprising a CD or floppy disc, for example, and manually loaded onto the target environment 182 and 184 by using the unpackaging utility 304 and configuration set 500. Many other means of transferring the installation data in the DAR file 320 to the target environment 182 and 184 exist, via infrared or LAN connections, to cite only two examples.

The result is the full deployment on server 2 182 of Web service application 1 240 and Web service 1 241 and on server 3 184 of the chained Web service 2 242.

Groupings of Web Services

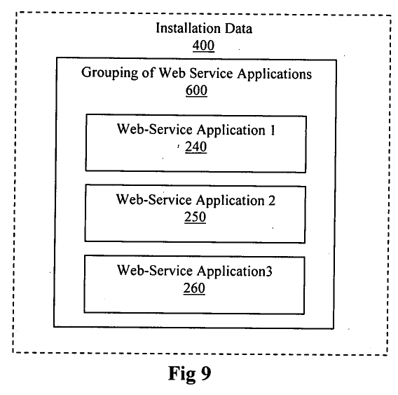

It is important to note that the installation data 400, shown in FIG. 7, for a DAR file 320 may be more complex than the set of elements previously shown. As presented in FIG. 9, installation data 400 for a single DAR file 320 may comprise a grouping of Web service applications 600, where multiple Web service applications, such as 240, 250, and 260, are associated into useful collections for deployment on the target environment 182 and 184, shown in FIG. 4.

Thus a single DAR file 320 may be used to deploy multiple Web service applications 240, 250, and 260, shown in FIG. 9, on the target environment 182 and 184, shown in FIG. 4.

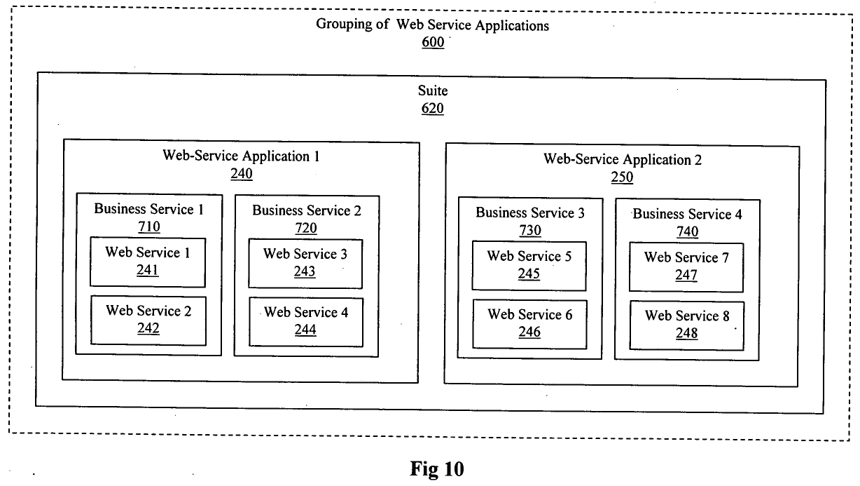

FIG. 10 shows a grouping of Web services 600 that comprises a suite 620 of Web service applications 240 and 250, which in turn incorporate business services 710, 720, 730, and 740, which in their turn incorporate Web services 241-248.

For example,
Suite 620 might be a suite of health transaction applications;
Web service applications 240 and 250 might be for claims filing and eligibility;
Business service 710 might be for claims submission; and
Web services 241 and 242 might be for claims validation and submission of claims to payers.

Computer System Overview

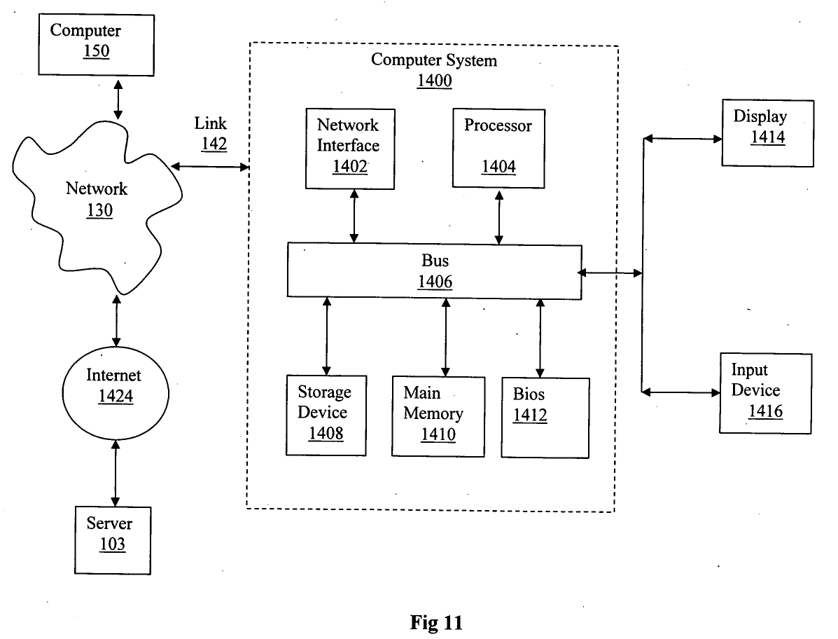

FIG. 11 is a block diagram that illustrates a typical computer system 1400, well known to those skilled in the art, representing a Web service application provider server 100, shown in FIG. 4, on which embodiments of the present invention can be implemented. This computer system 1400, shown in FIG. 11, comprises a network interface 1402 that provides two-way communications through a wired or wireless link 142 to a wired or wireless communications network 130 that uses any applicable communications technology. For example, the network 130 can comprise a public telephone network, a wireless network, a local area network (LAN), and any known or not-yet-know applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:

a processor 1404 for processing information;

a storage device 1408, such as an optical disc, a magneto-optical disc, or a magnet disc, for storing information and instructions;

main memory 1410, which is a dynamic storage device such as a random access memory (RAM) that stores information and instructions to be carried out by processor 1404; a bios 1412 or another form of static memory such as read only memory (ROM), for storing static information and instructions to be carried out by processor 1404; a display 1414, such as a liquid crystal display (LDC) or cathode ray tube (CRT) for displaying information to user of the computer system 1400; and an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can send data to target computer 150 and target server 103, through a network 130 such as the Internet, and appropriate links 142, such as wired or wireless ones, and its network interface 1402.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

Alternate Embodiments

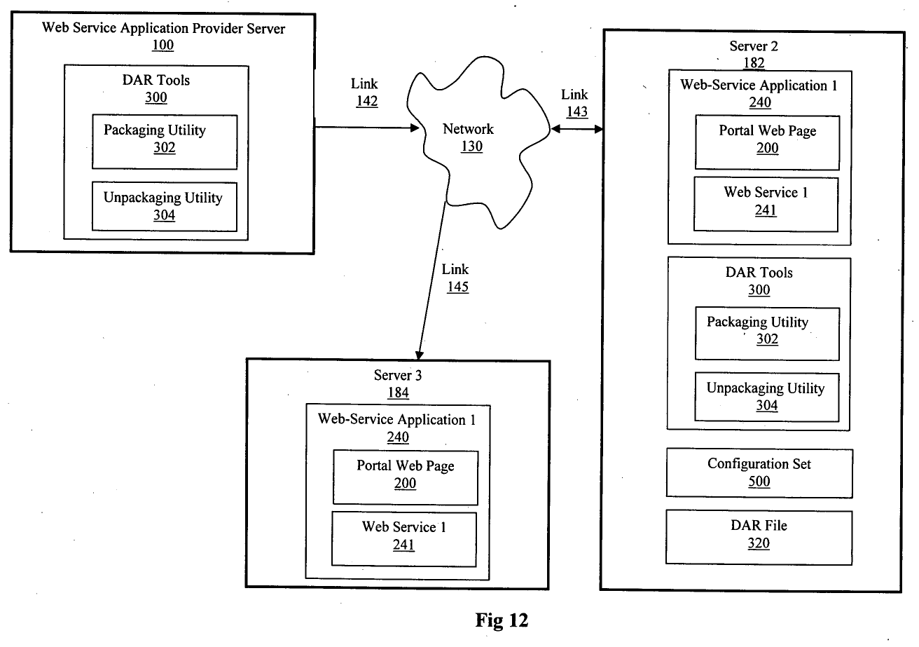

The descriptions above have outlined multiple alternate embodiments of the present invention. FIG. 12 shows an operating environment for an alternate embodiment, where the DAR tools 300 are created on one server 100 and sent over wired or wireless link 142, wired or wireless network 130, and wired or wireless link 143 to a second server 182. A party at server 182 can then use the DAR tools 300 to deploy any Web service application on its environment, such as Web service application 1 240 on another target environment, such as server 184.

It will be also apparent to those skilled in the art that different embodiments of the present invention may employ a wide range of possible hardware and of software techniques. For example the communication between a Web service application provider and target servers could take place through any number of links including wired, wireless, infrared, or radio ones and through other communication networks beside those cited, including any not yet in existence.

Also, the term computer as used here is used in its broadest sense to include personal computers, laptops, telephones with computer capabilities, personal data assistants (PDAs) and servers, and it should be recognized that it could include multiple servers, with storage and software functions divided among the servers. A wide array of operating systems, compatible e-mail services, Web browsers and other communications systems can be used to transmit messages among client applications and Web services.

Furthermore, in the previous description the order of processes, their numbered sequences, and their labels are presented for clarity of illustration and not as limitations on the present invention.

### Example of Code for a UDDI Entry

```
<uddi:tModel
xsi:type=“api:tModelExt”
tModelKey=“uddi:webifysolutions.com:hta:cfnr:submission:claims-
submission:wsdl”>
<uddi:name>
  webifysolutions-com:hta:cfnr:submission:claims-submission:wsdl
</uddi:name>
<uddi:description>
  Claims Submission WSDL
</uddi:description>
<uddi:categoryBag>
  <uddi:keyedReference
    keyName=“uddi-org:types:wsdl”
    keyValue=“wsdlSpec”
    tModelKey=“uddi:uddi.org:categorization:types”
  />
</uddi:categoryBag>
  <api:ResourceInstanceInfo>
    <api:accessLevel>
    public
  </api:accessLevel>
  <api:deploymentState>
    staging
  </api:deploymentState>
  <api:OwnerInfo>
    <types:emailAddress>
      admin@webifysolutions.com
    </types:emailAddress>
  </api:OwnerInfo>
</api:ResourceInstanceInfo>
</uddi:tModel>
```

### Example of Code for Application Wide Properties

The following code is an example of application wide properties used for the granting of roles 25 within an application.

```
<sec:GrantUserRole>
  <api:MemberRole>
      <uddi:name>
          Administrator
      </uddi:name>
      <api:OrganizationInfo>
          <uddi:name>
              Patient First
          </uddi:name>
      </api:OrganizationInfo>
  </api:MemberRole>
<api:UserInfo>
  <types:emailAddress>
      rick.gregory@patientfirst.com
  </types:emailAddress>
</api:UserInfo>
  </sec:GrantUserRole>
```

What is claimed is:

1. A method for installing on a first target environment a first Web service application created on a source environment, the method comprising the computer-implemented steps of
creating deployment archive, DAR, tools by
creating a packaging utility,
creating an unpackaging utility;
using the DAR tools to create a DAR file for the first Web service application created on the source environment;
obtaining a configuration set about the first target environment and the first Web service application; and
using the DAR tools with the configuration set to deploy the first Web service application on the first target environment.

2. The method of claim 1 wherein creating a packaging utility further comprises
creating a utility that
assembles installation data about the first Web service application, the
installation data comprising information about
a first Web service application,
at least one Web service used by the first Web service application, portlets, comprising programs that assemble information about the user interface for the first Web service application, such as portal Web pages,
executable programs used by Web services and portal pages to provide functionality, and
metadata entries comprising further information about the location and features of the first Web service application, and
packages the installation data into the DAR file.

3. The method of claim 2 wherein creating a utility that assembles installation data about executable programs further comprises
providing application-wide modules which are packaged in Java Archives, JARs.

4. The method of claim 2 wherein assembling installation data about metadata entries comprises
assembling UDDI entries;
assembling data about application-wide properties, the data comprising
the encryption level for messages,
business service levels, and
the timeout and number of retries used in communications; and
assembling data about hierarchies of applications-wide properties.

5. The method of claim 4 wherein assembling data about hierarchies further comprises
assembling data about a hierarchy comprising as categories
a suite of applications,
an application,
a business service, and
a Web service.

6. The method of claim 1 wherein creating an unpackaging utility further comprises
creating a utility to read the DAR file into a memory;
creating a utility to read a configuration set into the memory; and
creating a utility to write the contents of the DAR file according to the configuration set of the target environment.

7. The method of claim 1 wherein obtaining a configuration set about the first target environment and the first Web service application further comprises
creating the configuration set about the first target environment.

8. The method of claim 1 wherein using the DAR tools with the configuration set to deploy first Web service application on the first target environment further comprises
reading the DAR file into a memory on server which has access to the first target environment;
reading the configuration set about the first target environment into memory; and
writing the contents of the DAR file to the first target environment according to the configuration set.

9. The method of claim 1 further comprising
obtaining a configuration set about a second target environment and the Web service application;
using the DAR tools with the configuration set to deploy Web service application on the second target environment.

10. The method of claim 9 wherein obtaining a configuration set about the second target environment and the Web service application further comprises
creating the configuration set about the second target environment on the source environment.

11. The method of claim 9 wherein obtaining a configuration set about the second target environment and the Web service application further comprises
importing the configuration set about the second target environment from the second target environment.

12. The method of claim 9 wherein using the DAR tools with the configuration set about the second environment to deploy Web service application on the second target environment comprises
reading the DAR file into the memory;
reading the configuration set about the second target environment into the memory; and
writing the contents of the DAR file to the second target environment according to configuration set.

13. The method of claim 1 further comprising
using the DAR tools to create a DAR file for a second Web service application created on the source environment;
obtaining a configuration set about a target environment and the second Web service application;
using the DAR tools with the configuration set to deploy the second Web service application on the target environment.

14. The method of claim 13 wherein obtaining a configuration set about the target environment and the second Web service application further comprises
creating the configuration set about the target environment on the source environment.

15. The method of claim 13 wherein obtaining a configuration set about the target environment and the second Web service application further comprises
importing the configuration set about the target environment from the target environment.

16. The method of claim 13 wherein using the DAR tools to create a DAR file for a second Web service application created on the source environment further comprises
reading the DAR file into the memory;
reading the configuration set about the target environment into the memory; and
writing the contents of the DAR file to the target environment according to the configuration set.

17. A method for installing on a first target environment a first Web service application created on a source environment, the method comprising the computer-implemented steps of
using deployment archive, DAR, tools to create a DAR file for the first Web service application created on the source environment;
obtaining a configuration set about the first target environment and the first Web service application; and
using the DAR tools with the configuration set to deploy the first Web service application on the first target environment.

18. A method for creating deployment archive, DAR, tools to install on a first target environment a first Web service application created on a source environment, the method comprising the computer-implemented steps of
creating a packaging utility by
assembling installation data about the first Web service application, the installation data comprising information about
the first Web service application,
at least one Web service used by the first Web service application, portlets,
executable programs used by the first Web service application and portlets to provide functionality, and
metadata entries comprising further information about the location and features of the first Web service application, and
packaging the installation data about the first Web service application into a DAR file; and
creating an unpackaging utility by
creating a utility to read the DAR file into a memory,
creating a utility to read a configuration set into the memory, and
creating a utility to write the contents of the DAR file according to a configuration set of the first target environment.

19. An automatic method for installing on a target environment a first Web service application and a second Web service application created on a source environment, the method comprising the computer-implemented steps of
creating deployment archive, DAR, tools by
creating a packaging utility, and
creating an unpackaging utility;
using the DAR tools to create a first DAR file for the first Web service application created on the source environment;
obtaining a configuration set about the first target environment and the first Web service application;
using the DAR tools with the configuration set to deploy the first Web service application on the first target environment;
using the DAR tools to create a second DAR file for a second Web service application created on the source environment;
obtaining a configuration set about a target environment and the second Web service application; and
using the DAR tools with the configuration set to deploy the second Web service application on the target environment.

20. An automatic method for installing a plurality of Web service applications on a plurality of target environments, the method comprising the computer-implemented steps of
creating deployment archive, DAR, tools by
creating a packaging utility, and
creating an unpackaging utility;
using the DAR tools to create a first DAR file for a first Web service application;
obtaining a first configuration set about a first target environment and the first Web service application;
using the DAR tools with the configuration set to deploy the first Web service application on the first target environment;
obtaining a second configuration set about a second target environment and a second Web service application; and
using the DAR tools to deploy the second Web service application on the second target environment according to the second configuration set.

21. An automatic method for installing, on a first target environment, a first Web service application created on a source environment, the method comprising the computer-implemented steps of
creating deployment archive, DAR, tools by
creating a packaging utility by
assembling installation data about the first Web service application, the
installation data comprising information about
the first Web service application;
at least one Web service used by the first Web service application;
portlets,
executable programs used by the first Web service application and portlets to provide functionality, and
metadata entries comprising further information about the location and features of the first Web service application, and
packages the installation data about the first Web service application into a DAR file,
creating an unpackaging utility by
creating a utility to read the DAR file into a memory,
creating a utility to read a configuration set into the memory, and
creating a utility to write the contents of the DAR file according to a configuration set;
using the DAR tools to create the DAR file for the first Web service application created on the source environment;
obtaining the configuration set about the first target environment and the first Web service application; and
using the DAR tools with the configuration set to deploy the first Web service application on the first target environment by
reading the DAR file into the memory,
reading the configuration set about the first target
environment into the memory, and
writing the contents of the DAR file to the first target environment according to the configuration set.

22. Deployment archive, DAR, tools comprising
a packaging utility that assembles installation data about a Web service application and
packages that installation data for deployment on a target environment; and
an unpackaging utility comprising
a utility to read a DAR file into a memory;
a utility to read a configuration set into the memory; and
a utility to write the contents of a DAR file according to a configuration set.

23. A DAR file for installation data about a Web service application packaged for deployment on a target environment, the DAR file comprising installation data about
the first Web service application;
at least one Web service used by the first Web service application;
portlets,
executable programs used by the first Web service application and portlets to provide functionality, and
metadata entries comprising further information about the location and features of the first Web service application.

24. A configuration set to facilitate installing, on a target environment, a Web service application associated with a web service, the configuration set comprising
instructions for placing portal pages for the Web service application on the target environment;
instructions for placing executable programs for the Web service application on the target environment;
instructions for placing metadata entries for the Web service application in metadata storage on the target environment; and
instructions for placing programs for the Web service on the target environment.

25. A system for installing a first Web service application on a target environment and, the system comprising
a first Web service application;
a target environment server;
a configuration set about the target environment;
a Web service application server comprising
a memory,
deployment archive, DAR, tools comprising a packaging utility and an
unpackaging utility, and
a first DAR file for the first Web service application, such that the DAR tools facilitate reading the first DAR file into the memory, and facilitate reading the configuration set into the memory, and facilitate writing the contents of the first DAR file according to the configuration set to the target environment server; and
a network interface between the target environment server and the Web service application server.

26. The system of claim 25 further comprising
a second server, such that the DAR tools are transferred to the second server, and such that the DAR tools are used to create a second DAR file on the second server for the first Web service application, and such that the configuration set is provided on the second server, and such that the DAR tools and the configuration set are used on the second server to deploy the first Web service application to the target environment server; and
a network interface between the target environment server, the Web service application server, and the second server.
